(19) United States
(12) Patent Application Publication
(10) Pub. No.: US 2010/0076778 A1
(43) Pub. Date: Mar. 25, 2010

(54) Method and System for Providing and Maintaining Limited-Subscriptions to Digital Media Assets

(76) Inventors: Robert H. Kondrk, Los Angeles, CA (US); Patrice Gautier, San Francisco, CA (US); Jeffrey L. Robbin, Los Altos, CA (US); David Heller, Los Altos, CA (US); Augustin Farrugia, Cupertino, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/238,289

(22) Filed: Sep. 25, 2008

(51) Int. Cl. G06Q 30/00; G06F 7/06; G06F 17/30; G06F 15/16

(52) U.S. Cl. 705/1; 707/E17.014; 707/E17.01; 707/E17.108

(57) ABSTRACT

Systems, graphical user interfaces and methods for upgrading from one or more digital media assets to a set of digital media assets over a network are described. A potential purchaser can be notified of available upgrade opportunities that are available for purchase. The potential purchaser can elect to pursue an upgrade opportunity so as to purchase a set of digital media assets. Upon upgrading to the set of digital media assets, the digital media assets within the set of digital media assets are made available to the purchaser. According to one aspect, a graphical user interface facilitates presenting and requesting upgrade opportunities. According to another aspect, equivalency rules and/or eligibility rules can be used to control which sets of digital media assets are available for upgrade by respective potential purchasers.

### BACKGROUND OF THE INVENTION

1. Field of the Invention

The present invention relates to digital media assets and, more particularly, to access sets of digital media assets.

2. Description of the Related Art

Today, it is common for users to access on-line media repositories to purchase songs or tracks on-line. Recently, on-line media repositories have supported videos, such as movies or television shows. The typical interaction with an on-line media repository is that a user will browse the on-line media repository, select one or more media items to be purchased or otherwise acquired, and then receive electronic delivery of the items over a network. The cost to the user is dependent on the number of media items purchased and the cost associated with each of such media items. One example of an on-line media repository is an on-line media store, such as the iTunes® store provided by Apple Inc.

Another interaction with an on-line media repository can follow a subscription model. Under a subscription model, a user pays a monthly fee for a subscription and is permitted to select and download an unlimited number of media items. The selected one or more media items are electronically delivered to the user over a network. The cost to the user is the monthly fee regardless of how many or how few media items the user receives. One example of an on-line media repository with a subscription model is Rhapsody from RealNetworks, Inc. Rhapsody is offered as Rhapsody Unlimited, which gives you unlimited streams and downloads—but no transfers—to portable devices, or Rhapsody To Go, which allows you to listen to subscription-based downloads on compatible portable devices.

Unfortunately, however, users often do not have a desire for a subscription service on a continuous basis. On the other hand, in some cases, a subscription service can be more cost effective than separately purchasing media items. Hence, there is a need for improved approaches to facilitate user acquisition of media items.

### SUMMARY OF THE INVENTION

In one embodiment, the invention pertains to computer-implemented methods and systems for providing media updates to one or more electronic devices. The media updates can serve to provide to interested users certain digital media assets that satisfy predetermined criteria. The predetermined criteria can be based on one or more categories and on at least one ranking.

In one embodiment, the invention pertains to providing and maintaining limited subscriptions to digital media assets. A user entitled to a limited subscription to digital media assets can provide criteria used to identify the limited digital media assets to be made available to the user. The limited digital media assets can be associated with a media asset group. The limited digital media assets made available to the user can vary over time, and thus the delivery of the limited digital media assets can be automatically updated and/or maintained. The limited digital media assets can be delivered to an electronic device, such as a portable electronic device, associated with the user.

In general, the invention can be implemented in numerous ways, including as a method, system, device, apparatus (including graphical user interface or computer readable medium). Several embodiments of the invention are discussed below.

As a computer-implemented method for providing media updates to one or more electronic devices, one embodiment of the invention can, for example, include at least: providing a collection of media items; assigning one or more categories to the media items; assigning a ranking value to a plurality of the media items; identifying a set of the media items based on one or more categories and the ranking value; creating an electronic package of the set of media items; and transmitting the electronic package to an electronic device.

As a computer-implemented method for storing and updating media items to a hand-held electronic device, one embodiment of the invention can, for example, include at least: registering for access to a media asset group, the media asset group being defined by one or more user-specified characteristics; determining a plurality of media assets that are within the media asset group based on the one or more user-specified characteristics; delivering at least a subset of the determined media assets that are within the media asset group to the hand-held electronic device; and storing the subset of the determined media assets that are within the media asset group to the hand-held electronic device, whereby the hand-held electronic device is configured to present the media assets.

As a method for providing limited-subscription privileges to an online media repository, one embodiment of the invention can, for example, include at least: purchasing, by a purchaser, a limited subscription to an online media repository; identifying a media asset group as the limited subscription, the media asset group having a plurality of characteristics; determining media assets from the online media repository that are to be included in the media asset group; rendering the determined media assets available for download to the purchaser without additional charge; and subsequently downloading the determined media assets to the purchaser.

As a computer readable medium including at least executable computer program code stored thereon for providing limited-subscription privileges to an online media repository, one embodiment of the invention can, for example, include at least: computer program code for facilitating purchase, by a purchaser, of a limited subscription to an online media repository; computer program code for identifying a media asset group as the limited subscription; computer program code for determining media assets from the online media repository that are to be included in the media asset group; computer program code for rendering the determined media assets available for download to the purchaser without additional charge; and computer program code for downloading the determined media assets to the purchaser.

As a media update system, one embodiment of the invention can, for example, include at least: a media library configured to store a plurality of digital media assets, and a media update manager operatively connected to the media library. The media update manager can be configured to manage identification and delivery of the digital media assets that are within one or more media asset groups to one or more requesters. Each of the one or more media asset groups can be defined by a group criteria. The group criteria can be used to determine those of the digital media assets within the media library that are to be included in the respective media asset groups. The media update manager can prepare and send an initial media package to the requester for the media assets within the media asset group. The media update manager can also subsequently prepare and send a media update package to the requestor when the media assets within the media asset group have changed.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media purchase system according to one embodiment of the invention.

FIG. 2 is a flow diagram of a limited media delivery process according to one embodiment of the invention.

FIG. 3 is a block diagram of a media update system according to one embodiment of the invention.

FIG. 4 is a flow diagram of a media update configuration process according to one embodiment of the invention.

FIG. 5 is a flow diagram of a media group update process according to one embodiment of the invention.

FIG. 6 is a flow diagram of an update notification process according to one embodiment of the invention.

FIG. 7 is a flow diagram of an update delivery process according to one embodiment of the invention.

FIG. 8 is a flow diagram of a limited subscription process according to one embodiment of the invention.

### DETAILED DESCRIPTION OF THE INVENTION

In one embodiment, the invention pertains to computer-implemented methods and systems for providing media updates to one or more electronic devices. The media updates can serve to provide to interested users certain digital media assets that satisfy predetermined criteria. The predetermined criteria can be based on one or more categories and on at least one ranking.

In one embodiment, the invention pertains to providing and maintaining limited subscriptions to digital media assets. A user entitled to a limited subscription to digital media assets can provide criteria used to identify the limited digital media assets to be made available to the user. The limited digital media assets can be associated with a media asset group. The limited digital media assets made available to the user can vary over time, and thus the delivery of the limited digital media assets can be automatically updated and/or maintained. The limited digital media assets can be delivered to an electronic device, such as a portable electronic device, associated with the user. The user can pay a subscription fee, such as a monthly fee, to have access to the limited subscription.

In one embodiment, a user can subscribe to receive a media asset group that can dynamically change. For example, the user can subscribe to receive a “Top 10” songs media asset group, which will contain the top ten most popular songs. Hence, in this example, the user will receive the songs within the “Top 10” songs media asset group. Hence, as the songs in the Top 10 change, the songs within the media asset group change. The user can receive an update at the user's playback device whenever the songs within the “Top 10” songs media asset group change. As a result, the user has up-to-date access to the “Top 10” songs on the user's playback device.

The digital media assets can be audio, graphic, video, or some combination thereof. For example, the digital media assets (i.e., media items) can pertain to video items (e.g., video files or movies), audio items (e.g., audio files or audio tracks, such as for songs (music) or audiobooks), or image items (e.g., photos). The digital media assets can also include or be supplemented by text or multimedia files.

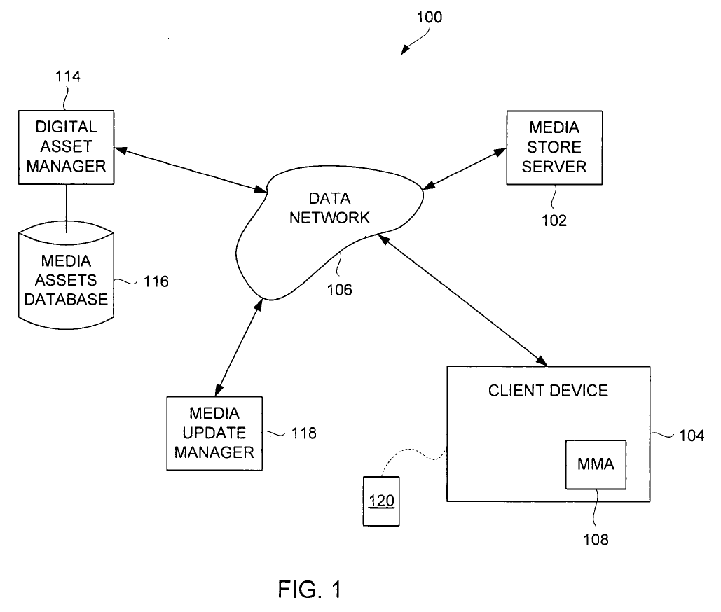

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a block diagram of a media purchase system 100 according to one embodiment of the invention. The media purchase system 100 includes a media store server 102 that hosts an on-line media store. The media store server 102 can off-load commerce transactions and/or delivery of purchased digital media assets to other servers, if desired. As shown in FIG. 1, the media purchase system 100 includes one or more client devices 104 for use by end users. The client devices 104 couple to a data network 106. Additionally, the media store server 102 also couples to the data network 106. In one implementation, the data network 106 can refer to one or more data networks, typically, high data-bandwidth networks, namely, wired networks, such as the Internet, Ethernet, gigabit Ethernet, and fiber optic, as well as wireless networks such as IEEE 802.11 (a),(b) or (g) (WiFi), IEEE 802.16 (WiMax), and Ultra-Wide Band (UWB).

A computer program 108, typically a media management application (MMA) or other media player application, runs on the client device 104. One example of a media management application is the iTunes® application, produced by Apple Inc. of Cupertino, Calif. The client devices 104 are, in general, computing devices. As an example, the client devices 104 can be specific or general-purpose personal computers or portable media players. The computer program 108 can be used by a consumer for a variety of purposes, including, but not limited to: (i) browsing and/or purchasing media assets (including sets of media assets) from the on-line media store provided by the media store server 102, (ii) creating and sharing playlists, (iii) organizing media assets, (iv) presenting/playing media assets, and/or (v) transferring media assets between client devices 104. In an alternative embodiment, the computer program 108 can be a network browser application (e.g., web browser).

The media purchase system 100 can also include a digital asset manager 114. The digital asset manager 114 is coupled to a media assets database 116. The media assets database 116 stores media asset information including metadata relating to digital media assets available for purchase (or other acquisition) at the on-line media store. In one embodiment, the digital asset manager 114 can control what media assets and media asset information are available on the on-line media store. The metadata can pertain to individual media assets (digital media assets) or media asset groups (digital media asset groups). One type of group of digital media assets is an album, such as an audio album or a video album. Another type of group of digital media assets is dynamic media asset group whose digital media assets are based on characteristics set by the user. Another type of group of digital media assets is a season or a series of media assets (e.g., television series or movie sequels). The digital assets within a media asset group can include video, music, text, and/or graphics files.

The media store server 102 enables the user of a particular client device 104 to purchase a set (e.g., group or collection) of media assets through on-line transactions. One specific example of a set of media assets that can be purchased is a limited subscription for a user-selectable media asset group. A media update manager 118 can operate to manage updates to media asset groups that users designate as their limited subscription. For example, when a user has identified a user-selectable media asset group to be received as their limited subscription, the initial set of media assets of the user-selectable media asset group can be delivered to client device 104 of the user. Thereafter, the media update manager 118 can monitor the user-selectable media asset group to determine when the media items within the user-selectable media asset group have changed.

When there has been a change to the user-selectable media asset group, the media update manager 118 can cause at least the new media assets within the user-selectable media asset group to be delivered to the user. Hence, if the user-selectable media asset group is dynamic, the media update manager 118 can ensure that those registered users for the user-selectable media asset group receive any new media assets.

For example, in one embodiment, a user can subscribe to receive a media asset group that can dynamically change. For example, the user can subscribe to receive a “Top 10” songs media asset group, which will contain the top ten most popular songs. Hence, in this example, the user will receive the songs within the “Top 10” songs media asset group. Hence, as the songs in the Top 10 change, the songs within the media asset group change. The user can receive an update at the user's playback device whenever the songs within the “Top 10” songs media asset group change. As a result, the user has up-to-date access to the “Top 10” songs on the user's playback device.

On-line transactions to purchase media items are also referred to as electronic commerce (e-commerce). Subsequently, the client device 104 can download the purchased media assets from the media store server 102, or some other server, such as the digital asset manager 114, via the data network 106. As will be understood by those familiar with data networks, other network configurations are possible. Furthermore, while the media store server 102 and the digital asset manager 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

Additionally, the client device 104 can be a portable computing device, such as a portable electronic device, that can connect to the data network 106 in a wireless and/or wired manner. Alternatively, the media purchase system 100 can have a portable electronic device 120 coupled thereto. In one implementation, the portable electronic device 120 is a hand-held electronic device (e.g., hand-held media playback device). More particularly, the portable electronic device 120 can connect to the client device 104 by a dock, a peripheral connection, or wirelessly. The MMA 108 on the client device 104 can be used to manage media assets on the portable electronic device 120. Here, media assets for the user-selectable media asset group (whether initial media assets or subsequent new media assets) can be delivered to the portable electronic device 120 by way of the client device 104. Alternatively, the portable electronic device 120 can include its own MMA. The client device 104 and/or portable electronic device 120 can serve as a user's playback device.

A media asset group can have an inherent limit on its number of media assets. For example, a “Top 10 pop hits” media asset group can be limited to ten (10) songs. The system can also impose a limit on a requestor. For example, a limited subscription could be limited to twenty (20) media items. In such case, even if the media asset group has forty (40) media items, the requester would only received twenty (20) of the media items. However, the system can (i) randomly select the twenty (20) to be delivery to the user, (ii) choose the twenty (20) based on another criteria, and/or (iii) rotate through the forty (40) over time (e.g., with the user only having at most twenty (20) at a time. The requestor might have themselves impose a limit on the number of media assets from a media asset group that are to be delivered. Still further, the requestor's device can impose a limit, such as through available storage space or allocated storage space.

In one embodiment, a user can register for a subscription to provide a media asset group, as designed by the user, to a portable electronic device (e.g., hand-held electronic device, such as a portable media player). As noted above, the size or number of the media assets within the media asset group can be limited. In one implementation, the media assets within the media asset group are periodically updated. The periodic updating can cause the media assets to refresh to receive other media assets within the media asset group. Here, the media assets within the media asset group can be cycled through so that a fresh subset can reside on the portable electronic device. The periodic updating can alternatively or additionally refresh the media assets to include those media assets that are now part of the media asset group. In this case the media asset group is dynamic because those of the media assets within the media asset group changes. For example, a media asset group dependent on a ranking can be periodically updated because as rankings change so does those of the media assets that are within the media asset group.

In one embodiment, for those media items of the media asset group that have been provided to the portable electronic device, a user can make use of the media item, such as by playing the media item. Since a given media item may not remain in the media asset group, the user can not necessarily make use of the media items that have a one point been delivered to the portable electronic device as part of the media asset group being subscribed to. However, in one embodiment, the user may be able to request to keep a particular one or more of the media assets on the portable electronic device (or the client device). Such may or may not require the user to purchase the one or more media assets.

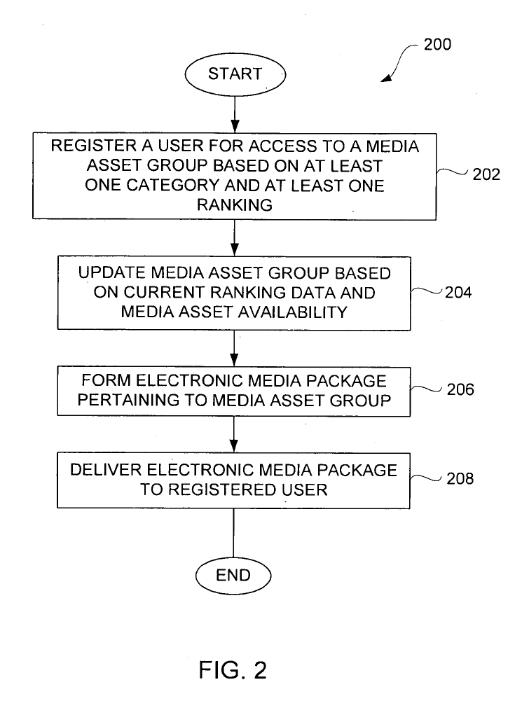

FIG. 2 is a flow diagram of a limited media delivery process 200 according to one embodiment of the invention. The limited media delivery process 200 concerns a process through which certain limited media can be delivered to registered users in a controlled, efficient and automated manner.

The limited media delivery process 200 can register 202 a user for access to a media asset group. The media asset group can, in one embodiment, be based on at least one category and at least one ranking. In other words, the media asset group can be determined based on the at least one category and the at least one ranking of various media assets. A category can, for example, by any of: media type (music, video, TV, podcast, etc.), genre (rock, country, hip-hop, etc.), artist, composer, or time period (e.g., year or period). The ranking is, for example, a ranking performed by an online store (e.g., online store offering the media asset group) or an independent body. Examples of rankings are popularity rankings, such as Billboard 100, most popular iTunes songs, etc.

The media asset group can be updated 204 based on current ranking data and media asset availability. For example, as rankings of media assets change, such as on a daily basis, and as media assets become newly available, the media assets within a media asset group can change. Hence, by updating 204 the media asset group, the media asset group is able to remain current. Once the media asset has been updated 204, the media asset group includes or references a particular set of media assets. As one example, the media asset group can be “Top 10 Most Popular Country Songs on iTunes Store,” where the category is the genre “country” and the ranking is based on the iTunes sale popularity rankings.

An electronic media package can be formed 206 pertaining to the media asset group. The electronic media package can then be delivered 208 to in the one or more registered users. As a result, the registered users can periodically receive an electronic media package that contains (or links to) content for one or more of the media assets within the media asset group. A registered user can then store the media assets within the electronic media package to one or more electronic devices associated with the registered user. At this point, the user is able to utilize the media assets on the one or more electronic devices. For example, in the case in which the media assets are audio assets, such as music, once stored to an electronic device, the electronic device is able to playback the audio assets.

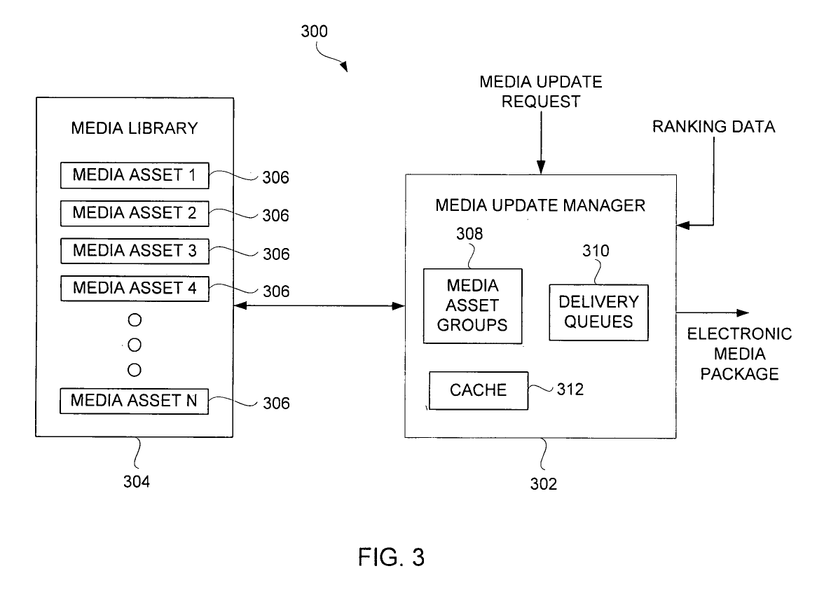

FIG. 3 is a block diagram of a media update system 300 according to one embodiment of the invention. The media update system 300 includes a media update manager 302 and a media library 304. As media assets become available to the media update system 300, the media assets are placed in the media library 304. As illustrated in FIG. 3, the media library 304 includes a plurality of media assets 306. In particular, the media library 304 is illustrated as including media asset 1, media asset 2, media asset 3, media asset 4, . . . , media asset N. The media update manager 302 receives a media update request from the user. The media update request is a request from the user to participate in a particular media asset group. The particular media asset group can be already formed or can be newly created.

The media update manager 302 can include a plurality of media asset groups 308. The media asset groups 308 are categorizations of media assets that are of interest to users. For each of the media asset groups 308, the media update manager 302 can store an indication of the media assets 306 within the particular media asset group 308. In determining which of the media assets 306 are to be deemed within each of the media asset groups 308, the media update manager can utilize rankings (ranking data) received by the media update system 300.

As the media asset groups 308 that have been updated, such as due to the presence of new media assets 306, those previously registered users can receive an electronic media package. The electronic media package delivers one or more of the media assets (or a link thereto) of a media asset group to a registered user. The media update manager 302 can cause the electronic media package to be sent to the registered users. For the different registered users, the media update manager 302 can include (or couple to) delivery queues 310. The delivery queues 310 can facilitate delivery of media assets of the media asset groups to the different registered users. When it is appropriate for the electronic media packages to be delivered, the electronic media packages can be identified within the delivery queues 310 and the appropriate media assets delivered within the electronic media packages. To facilitate efficient delivery of media assets, the media update manager can include (or couple to) a cache 312. The cache 312 can store one or more media assets that are to be utilized in the delivery of the electronic media packages to the registered users. For example, the cache 312 can store content data pertaining to those of the media assets in the media asset groups that are available to be delivered.

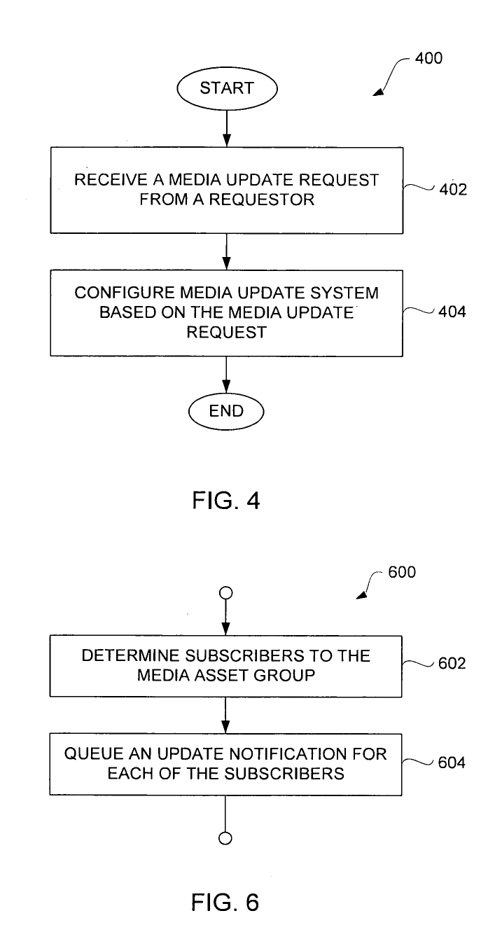

FIG. 4 is a flow diagram of a media update configuration process 400 according to one embodiment of the invention. The media update configuration process 400 can, for example, be performed by the media purchase system 100 illustrated in FIG. 1 or the media update system 300 illustrated in FIG. 3. The media update configuration process 400 can pertain to configuration of a media update.

The media update configuration process 400 can receive 402 a media update request from a requestor. Then, the media update system (e.g., media update system 300) can be configured 404 based on the media update request. Here, the media update system, in response to the media update request, operates to configure the media update system to support the media update request. Following the block 404, the media update configuration process 400 can end.

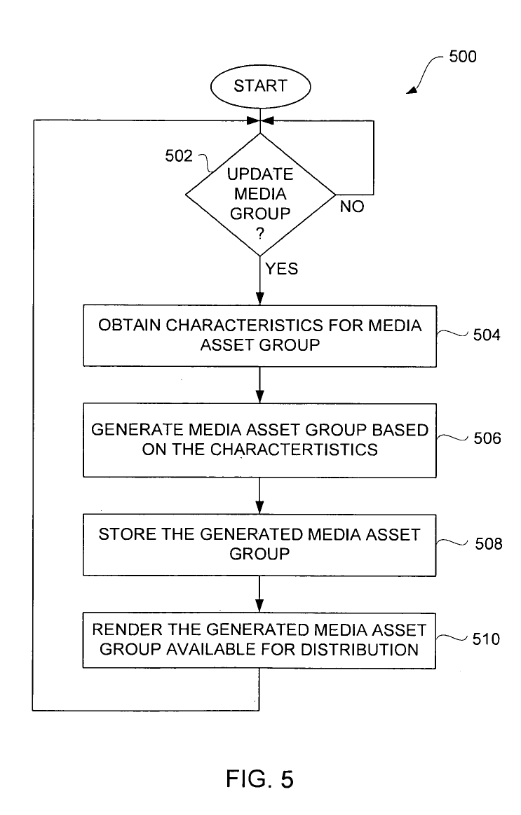

FIG. 5 is a flow diagram of a media group update process 500 according to one embodiment of the invention. The media group update process 500 can, for example, be performed by the media purchase system 100 illustrated in FIG. 1 or the media update system 300 illustrated in FIG. 3. The media group update process 500 can began with a decision 502 that determines whether a media group is to be updated. When the decision 502 determines that a media group is not to be updated, the media group update process 500 awaits the need for an update. On the other hand, when the decision 502 determines that a media group is to be updated, then the media group update process 500 continues. In this regard, characteristics for the media asset group are obtained 504. Each media asset group typically has characteristics that define its group so as to be able to determine whether a media asset are to be included in the media asset group. The media asset group is generated 506 based on the characteristics. Here, those media assets that are to be included within the media asset group are determined based on the characteristics for the media asset group. Next, the generated media asset group is stored in 508. Thereafter, the generated media asset group is rendered to 510 available for distribution. Following the block 510, the media group update process 500 can return to repeat the decision 502 so that subsequent media group updates can be similarly processed.

FIG. 6 is a flow diagram of an update notification process 600 according to one embodiment of the invention. The update notification process 600 can, for example, be performed by the media purchase system 100 illustrated in FIG. 1 or the media update system 300 illustrated in FIG. 3. The update notification process 600 serves to notify requestor's when updates to media asset groups are available. In particular, subscribers (or requesters) to the media asset group can be determined 602. Here, the media has information concerning the various media asset groups that are being processed. An update notification for each of these subscribers can then be queued 604. The delivery of the update notifications for the various subscribers can be performed in a variety of different ways. For example, the notifications can be sent differently with respect to different devices or types of devices. Following the block 604, the update notification process 600 can end. In one embodiment, the notification can be sent in advance of an electronic media package. In another embodiment, the notification can be sent as part of the electronic media package.

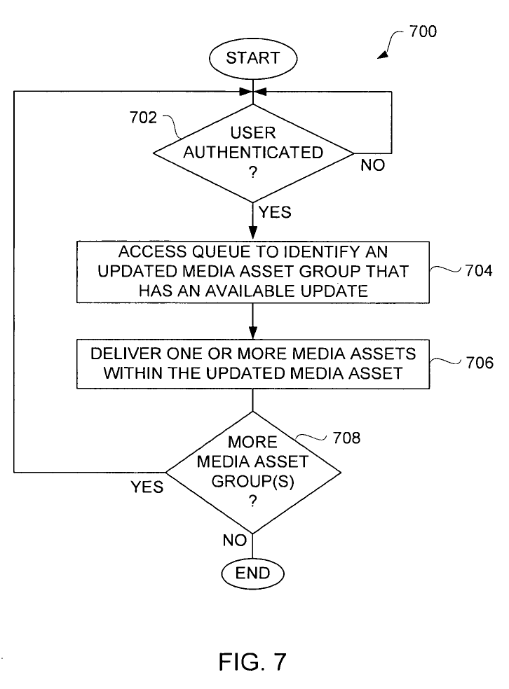

FIG. 7 is a flow diagram of an update delivery process 700 according to one embodiment of the invention. The update delivery process 700 can, for example, be performed by the media purchase system 100 illustrated in FIG. 1 or the media update system 300 illustrated in FIG. 3. The update delivery process 710 began with a decision 702 that determines whether a user requesting access to the media group distribution system has been authenticated. When the decision 702 determines that the user has been properly authenticated, the update delivery process 700 can continue. However, when the decision 702 determines that the user has not been successfully authenticated, the update delivery process 700 awaits appropriate user authentication.

Once the user has been properly authenticated, a queue can be accessed 704 to identify an updated media asset group that has an available update. Next, one or more media assets within the updated media asset can be delivered 706. A cache (e.g., cache 312) can be used to more efficiently deliver content data for the one or more media assets within the updated media asset to be delivered 706. A decision 708 then determines whether more media asset groups are to be processed. When the decision 708 determines that there are more media asset groups to be processed, the update delivery process 700 can return to repeat the decision 702 (or alternatively) the block 704. On the other hand, when the decision 708 determines that there are no more media asset groups to be processed, the update delivery process 700 can end.

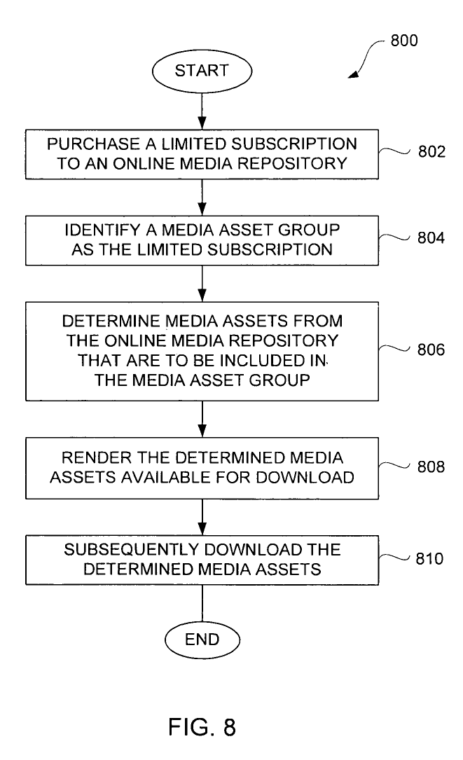

FIG. 8 is a flow diagram of a limited subscription process 800 according to one embodiment of the invention. The limited subscription process 800 can, for example, be performed by the media purchase system 100 illustrated in FIG. 1 or the media update system 300 illustrated in FIG. 3.

The limited subscription process 800 can purchase 802 a limited subscription from an online media repository. For example, a purchaser can purchase the limited subscription from an online media store, such as the media store hosted by the media store server 102 illustrated in FIG. 1. In one embodiment, the limited subscription entitles the purchaser to gain access to a limited amount of user-specified media content available from the online media store.

After purchasing 802 the limited subscription, the purchaser can identify 804 a media asset group as the limited subscription. For example, in one embodiment, the purchaser of the limited subscription is able to specify a particular media asset group the purchaser desires to have access to. In other words, the limited subscription can allow the purchaser to have access to a media asset group. The media asset group can have predetermined characteristics or user-determined characteristics. The media items within the media asset group can be fixed or dynamic. One example of a dynamic media asset group is a media asset group that is dependent on a characteristic that changes. Here, the characteristic can be a ranking of media items. The online music store providing the media asset group can provide its own ranking (e.g., Top Songs (from iTunes Store). The characteristic or ranking can also be independently determined. Examples of independent rankings for media items are the billboard charts (e.g., Billboard Hot 100, Top 40 Mainstream, etc.).

Once the media asset group has been identified, media assets from the online media repository that are to be included in the media asset group can be determined 806. Here, based on the characteristics of the media asset group, those one or more media assets that are to be included in the media asset group can be determined. Since the characteristics can by dynamic, the media assets within the media asset group can also be dynamic. In one implementation, the number of media assets within the media asset group can be limited. For example, if the characteristic for the media asset group as the limited subscription is based on the “Top 40 Mainstream” billboard chart ranking, then the ranking can change (e.g., daily), and as a consequence, the media asset group can also change daily. Also, the limited subscription can have a maximum number of media assets, in which case the media asset group is limited to the maximum number. As an example, if the limit is ten (10) media assets, even though the ranking serves to rank more than ten (10) media assets, the media asset group would be limited to the top ten (10) of the ranked media assets.

After the media assets for the media asset group are determined 806, the determined media assets available can be rendered 808 for download. The determined media assets can be subsequently downloaded 810. Following the block 810, the limited subscription process 800 can end. The delivery of at least those of the determined media assets to the purchaser of the limited subscription service can be arranged. In one implementation, the determined media assets can be stored to a delivery queue associated with the purchaser, then subsequently downloaded from the delivery queue and/or a cache (storing the media content) to the purchaser when the purchaser has network access.

The electronic device may further be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with a user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of certain embodiment of the invention is that user can receive media items from a media asset group that dynamically changes, such as in accordance with rankings. Another advantage of the invention is that a user can purchase a limited subscription right to receive media items that satisfy certain user-provided conditions. Still another advantage of the invention is that media items from a media asset group can be automatically delivered to a portable electronic device (e.g., portable media player),

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for providing media updates to one or more electronic devices, said method comprising:
providing a collection of media items;
assigning one or more categories to the media items;
assigning a ranking value to a plurality of the media items;
identifying a set of the media items based on one or more categories and the ranking value;
creating an electronic package of the set of media items; and
transmitting the electronic package to an electronic device.

2. A computer-implemented method as recited in claim 1, wherein said electronic device is a hand-held device.

3. A computer-implemented method as recited in claim 1, wherein said method further comprising:
receiving a registration for said hand-held device, wherein the hand-held device has a unique identifier; and
determining if said hand-held device is authorized to receive said electronic package.

4. A computer-implemented method as recited in claim 1, wherein the electronic package comprises a list of media items.

5. A computer-implemented method as recited in claim 4, wherein said method further comprises:
transmitting an individual one of the media items to said electronic device upon request from said electronic device for the media item in the list.

6. A computer-implemented method as recited in claim 1, wherein said transmitting comprises:
determining an amount of available free space on the electronic device, and
limiting a size of the electronic package to an amount less than the available free space.

7. A computer-implemented method as recited in claim 1, wherein the electronic package comprises multiple audio files.

8. A computer-implemented method as recited in claim 1, wherein the electronic package comprises multiple video files.

9. A computer-implemented method as recited in claim 7, wherein the ranking values are based on popularity of the media items.

10. A computer-implemented method as recited in claim 7, wherein the ranking values are based on a billboard ranking.

11. A computer-implemented method as recited in claim 1, wherein the set of media items comprise audio files available in a subscription-based download service.

12. A computer-implemented method as recited in claim 1, wherein the electronic package includes an expiration date.

13. A computer-implemented method as recited in claim 1, wherein said method further comprises:
limiting the set of media items to a pre-determined number of media items.

14. A computer-implemented method as recited in claim 1,
caching the electronic package in storage for subsequent transmission to additional electronic devices.

15. A computer-implemented method as recited in claim 1, wherein the electronic package is authorized for registered devices.

16. A computer-implemented method for storing and updating media items to a hand-held electronic device, said method comprising:
(a) registering for access to a media asset group, the media asset group being defined by one or more user-specified characteristics;
(b) determining a plurality of media assets that are within the media asset group based on the one or more user-specified characteristics;
(c) delivering at least a subset of the determined media assets that are within the media asset group to the hand-held electronic device; and
(d) storing the subset of the determined media assets that are within the media asset group to the hand-held electronic device, whereby the hand-held electronic device is configured to present the media assets.

17. A computer-implemented method as recited in claim 16, wherein said method periodically repeats said determining (b), said delivering (c) and said storing (d) so as to dynamically update the subset of the determined media assets that stored to the hand-held electronic device.

18. A computer-implemented method as recited in claim 16,
wherein one of the one or more user-specified characteristics concerns a ranking of media items, and
wherein said determining (b) comprises:
obtaining ranking information pertaining to the ranking of media items; and
determining the media assets that are within the media asset group based on at least the ranking information.

19. A computer-implemented method as recited in claim 16, wherein said method comprises:
(e) periodically updating the subset of the determined media assets being delivered to the hand-held electronic device so that another subset of the determined media assets is delivered to and stored on the hand-held electronic device.

20. A method for providing limited-subscription privileges to an online media repository, said method comprising:
(a) purchasing, by a purchaser, a limited subscription to an online media repository;
(b) identifying a media asset group as the limited subscription, the media asset group having a plurality of characteristics;
(c) determining media assets from the online media repository that are to be included in the media asset group;
(d) rendering the determined media assets available for download to the purchaser without additional charge; and
(e) subsequently downloading the determined media assets to the purchaser.

21. A method as recited in claim 20, wherein said method further comprises:
(f) thereafter determining whether to update the media asset group; and
(g) repeating said determining (c), said rendering (d) and said (e) downloading if said determining (f) determines that the media asset group is to be updated.

22. A method as recited in claim 20, wherein said method further comprises:
(f) determining whether one or more different media assets that are now within the media asset group; and
(g) rendering the one or more different media assets available for download to the purchaser without additional charge.

23. A method as recited in claim 22, wherein the media assets within the media asset group are dynamic.

24. A method as recited in claim 20, wherein at least one characteristic of the media asset group is a ranking for media assets.

25. A method as recited in claim 24, wherein as the ranking for media assets change, the media assets with the media asset group change.

26. A method as recited in claim 20, wherein at least one characteristic of the media asset group is a popularity indication for media assets.

27. A method as recited in claim 20, wherein said determining (c) comprises limiting the number of the media assets within the media asset group to a maximum number.

28. A computer readable medium including at least executable computer program code stored thereon for providing limited-subscription privileges to an online media repository, said computer readable medium comprising:
computer program code for facilitating purchase, by a purchaser, of a limited subscription to an online media repository;
computer program code for identifying a media asset group as the limited subscription;
computer program code for determining media assets from the online media repository that are to be included in the media asset group;
computer program code for rendering the determined media assets available for download to the purchaser without additional charge; and
computer program code for downloading the determined media assets to the purchaser.

29. A media update system, comprising:
a media library configured to store a plurality of digital media assets; and
a media update manager operatively connected to said media library, said media update manager being configured to manage identification and delivery of the digital media assets that are within one or more media asset groups to one or more requestors,
wherein each of the one or more media asset groups is defined by a group criteria, the group criteria being used to determine those of the digital media assets within said media library that are to be included in the respective media asset groups,
wherein said media update manager prepares and sends an initial media package to the requestor for the media assets within the media asset group, and
wherein said media update manager prepares and sends a media update package to the requestor when the media assets within the media asset group have changed.

30. A media update system as recited in claim 29, wherein the group criteria is specified or selected by the requestor.

31. A media update system as recited in claim 29, wherein the group criteria for at least one of the media asset groups includes or is dependent upon at least a ranking.

32. A media update system as recited in claim 29,
wherein said media update manager can utilize a delivery queue to identify one or more digital media assets of the media asset group associated with the requester, and
wherein when the requester has network connectivity with a wireless network, the one or more digital media assets specified by the delivery queue are sent to the requester.
